(19) United States
(12) Patent Application Publication
(10) Pub. No.: US 2026/0037809 A1
(43) Pub. Date: Feb. 5, 2026

(54) MACHINE LEARNING PROCESSING USING FLEXIBLE BIT TRUNCATION

(71) Applicant: University of South Alabama, Mobile, AL (US)

(72) Inventors: Na Gong, Mobile, AL (US); William Donald Oswald, Mobile, AL (US); Jinhui Wang, Mobile, AL (US); Mohamed Elsaid Shaban, Mobile, AL (US); Md. Bipul Hossain, Mobile, AL (US)

(73) Assignee: University of South Alabama, Mobile, AL (US)

(21) Appl. No.: 19/304,648

(22) Filed: Aug. 20, 2025

Related U.S. Application Data
(63) Continuation-in-part of application No. 19/287,955, filed on Aug. 1, 2025.
(60) Provisional application No. 63/678,604, filed on Aug. 2, 2024.
(60) Provisional application No. 63/685,646, filed on Aug. 21, 2024.

(51) Int. Cl. G06N 3/082

(52) U.S. Cl. CPC G06N 3/082

(57) ABSTRACT

A machine learning network is accessed. The network includes one or more processing layers. At least one of the processing layers is sourced with flexible bit truncation storage hardware. A flexible bit truncation setting is determined for the at least one of processing layers. The determining is based on an application to be executed on the network. At least one additional flexible bit truncation setting is determined, enabling at least two processing layers to be sourced with flexible bit truncation storage hardware. At least one of the additional flexible bit truncation settings is different from the flexible bit truncation setting. The flexible bit truncation setting is programmed in the flexible bit truncation storage hardware of the processing layers. The application is executed using the flexible bit truncation setting. The flexible bit truncation storage hardware comprises a static RAM (SRAM).

### RELATED APPLICATIONS

This application claims the benefit of U.S. provisional patent application “Machine Learning Processing Using Flexible Bit Truncation” Ser. No. 63/685,646, filed Aug. 21, 2024.

This application is also a continuation-in-part of U.S. patent application “Machine Learning Processing Using Flexible Bit Truncation” Ser. No. 19/287,955, filed Aug. 1, 2025, which claims the benefit of U.S. provisional patent applications “Random Access Memory Using Flexible Bit Truncation” Ser. No. 63/678,604, filed Aug. 2, 2024, and “Machine Learning Processing Using Flexible Bit Truncation” Ser. No. 63/685,646, filed Aug. 21, 2024.

Each of the foregoing applications is hereby incorporated by reference in its entirety.

### STATEMENT REGARDING FEDERALLY SPONSORED RESEARCH OR DEVELOPMENT

This invention was made with government support under OIA2218046 awarded by the National Science Foundation. The government has certain rights in the invention.

### FIELD OF ART

This application relates generally to machine learning processing and more particularly to machine learning processing using flexible bit truncation.

### BACKGROUND

Data today is the most highly prized commodity of nearly every organization. Successful data collection, analysis, and utilization can make or break an organization. Data is routinely collected from individuals, groups, web-connected devices, and e-commerce websites, among other sources. Data is collected either quietly or actively as a user navigates websites. Data collection ranges from silently monitoring website visit details to actively collecting personal information and login credentials. Organizations, including research laboratories and academic institutions, analyze their data for scientific purposes, including advancing basic science, solving complex problems, and executing rapid responses to emergency situations. Other organizations analyze the data to develop investment strategies, to plan renewable energy sources, or to predict the hottest new holiday toy. Data is also routinely analyzed for political advertising strategies and poll data analysis. The data analysis strategies benefit when the amount of data available for analysis is large, and the sources of the data are diverse. Yet, the data can be misleading, particularly when the sources of the data have been corrupted.

Electronic devices including personal electronic devices have become immensely popular. The most favored personal electronic device, the smartphone, now enables individuals nearly anywhere in the world to communicate using voice, text, and email. These devices also access ecommerce websites to enable ordering and paying for goods and services online. The devices further support financial services such as online banking, stock trading, currency exchange, and bill pay. The phones further support information consumption including obtaining news, weather, and sports information such as World Cup scores or Olympic medal counts. The phones also provide access to maps, jungle gym plans, ride sharing, and short-term house rentals.

Internet connections enable the success of the personal electronic devices. The Internet further enables electronic building monitoring devices, fire protection, and food stock viability. These latter devices, often referred to as the Internet of Things (IoT), include smart thermostats; fire, smoke, and carbon monoxide detectors; and appliances. These smart devices support households and organizations, monitoring energy usage, supply levels, and safety. The data collected from the personal electronic and IoT devices greatly expands the types of data that are collected, and the services that can be provided based on the data. Additionally, data can be collected from a more diverse group of individuals. The diversity of the individuals, and the diversity of the data they provide, greatly enhances research and analysis tasks. The data analysis is able to better understand gender, cultural, and geographical preferences for goods and services, information sources, purchasing, and media sources. This diverse information further enables analysis of energy efficiency and usage, incidence and spread of disease, and damage associated with naturally occurring events including storms and political events such as war. However, all this data needs to be stored and processed in order to be useful.

### SUMMARY

Applications such as artificial intelligent (AI) applications are developed to analyze many different data types. One prominent technique for applying AI to process and analyze data is based on machine learning (ML) algorithms or models. An ML model can be trained to analyze a data type such as image data by training the model with a training dataset. Once trained and tested, the ML model can be used to analyze additional image data. The analysis can include classifying the image file to determine whether the image belongs to a class such as “image of a dog” or not. The analysis is accomplished by loading the trained model onto a machine learning network. The ML network includes one or more processing layers such as convolutional layers. As the ML model becomes more complex, and the number of layers in the ML network increases, the computational complexity of the analysis becomes greater. A method proposed here reduces the complexity of the analysis and other operations by truncating least significant bits from data such as image data. The number of bits that are truncated can be flexible, ranging from zero truncation bits to many truncation bits. A flexible bit truncation setting, which enables a tradeoff between computational complexity and processing result accuracy, can be determined. Once determined, the flexible bit truncation setting can be used to program flexible bit truncation hardware which then sources the truncated data to processing layers within the ML network. An added benefit of the bit truncation is reduced power consumption, and by extension heat dissipation, by the ML network.

Techniques for machine learning processing using flexible bit truncation are disclosed. A machine learning network is accessed. The ML network can include one or more layers, where the layers can include an input layer, an output layer, an intermediate or hidden layer, and so on. A layer of the ML network can include a convolutional layer. At least one of the processing layers is sourced with flexible bit truncation storage hardware. The flexible bit truncation storage hardware truncates the storage contents before sourcing them to a layer. A flexible bit truncation setting is determined for the at least one of the one or more processing layers. The determining the truncation setting can be based on analyzing the number of bits that can be truncated while maintaining processing accuracy by the ML network. Further, the determining is based on an application to be executed on the machine learning network. The determining can be based on a number of bits associated with data elements to be processed by the ML network. The flexible bit truncation setting is programmed in the flexible bit truncation storage hardware of the at least one of the one or more processing layers. The flexible bit truncation setting occurs in real time during application runtime. Further, the programming the flexible bit truncation setting changes dynamically during runtime. The application is executed using the flexible bit truncation setting. The execution can include generating a classification, converging on an inference, and so on.

A method for machine learning processing is disclosed comprising: accessing a machine learning network, wherein the machine learning network includes one or more processing layers, and wherein at least one of the one or more processing layers is sourced with flexible bit truncation storage hardware; determining a flexible bit truncation setting for the at least one of the one or more processing layers, wherein the determining is based on an application to be executed on the machine learning network; programming the flexible bit truncation setting in the flexible bit truncation storage hardware of the at least one of the one or more processing layers; and executing the application, using the flexible bit truncation setting. In embodiments, at least two of the one or more processing layers are sourced with flexible bit truncation storage hardware. Some embodiments comprise determining at least one additional flexible bit truncation setting. In embodiments, the at least one additional flexible bit truncation setting is different from the flexible bit truncation setting. Some embodiments comprise programming the at least one additional flexible bit truncation setting in another of the one or more processing layers. In embodiments, the executing includes using the at least one additional flexible bit truncation setting.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for machine learning processing using flexible bit truncation.

FIG. 2 is a flow diagram for application cataloging.

FIG. 3 is a system block diagram for machine learning using flexible bit truncation.

FIG. 4 is a plot showing performance of deep learning using flexible bit truncation.

FIG. 5 shows classification accuracy of a convolutional neural network (CNN) with different truncation bits and values.

FIG. 6 is a system block diagram showing truncation management and power gating.

FIG. 7 shows an example memory structure.

FIG. 8 illustrates truncation manager circuitry and a truth table.

FIG. 9 shows an example six-transistor bit cell with power gates.

FIG. 10 is a system diagram for a machine learning processing using flexible bit truncation.

### DETAILED DESCRIPTION

Techniques for machine learning processing using flexible bit truncation are disclosed. Artificial intelligence (AI) in general, and machine learning (ML) in particular, have become popular and powerful tools for processing data. One key reason for the popularity of ML and AI is that processing data with these tools can identify objects, patterns, and more within the data. While a human can examine an image of a dog and readily identify the contents of the image as being a dog, processing techniques prior to the introduction of AI and ML algorithms and models had extreme difficulty in reliably identifying or classifying the contents of the data. Now, AI and ML functions, algorithms, and techniques are widely available through various interfaces and applications. However, processing data using AI and ML techniques can be computationally demanding, particularly when the amount of data to be processed is large and the AI or ML tools are complex. Further, data storage requirements can be immense. Disclosed techniques can greatly reduce data storage needs and data processing requirements while maintaining a necessary level of computational accuracy by flexibly truncating storage bits of data sourced to a machine learning network. As an additional benefit, the truncating storage bits can save power. This allows an AI application or ML model requiring different precisions to run on the same hardware. In addition, the truncation enables a reduction in precision while maintaining output accuracy such as classification accuracy and inference accuracy. Thus, storage is saved and computational complexity is reduced in a flexible manner, according to the computational needs of the running application, sub-application, network layer, inference engine, etc.

Machine learning processing is enabled using flexible bit truncation. The machine learning processing can include classifying data to be included in a class or not included in a class, drawing inferences about the data, and so on. The data can include audio data, image data, video data, and so on. The processing requirements of the data can be reduced while maintaining processing accuracy using flexible bit truncation. The flexible bit truncation truncates least significant bits (LSBs) of a data element sourced from flexible bit truncation storage hardware. The bit truncation is determined by analyzing an application to be run on a network such as a machine learning network. A bit truncation setting is determined by analyzing an application for output accuracy as the number of truncated bits increased. A setting can include a maximum number of bits that can be terminated while maintaining high processing accuracy. The bit truncation setting is used to program flexible bit truncation storage, where the flexible bit truncation hardware sources the truncated data to a layer within a network such as a machine learning network. The application can then be executed using the flexible bit truncation setting.

A machine learning (ML) network is accessed. The ML network can be based on a processing network such as a convolutional neural network (CNN). Other ML networks can be employed, such as a lightweight model with pruning. The network can include one or more processing layers such as one or more of an input layer, an output layer, an intermediate or hidden layer, and so on. The at least one of the one or more processing layers is sourced with flexible bit truncation storage hardware. The flexible bit truncation storage hardware can truncate bits from stored data. The number of truncated bits can include zero bits, one bit, two bits, etc. A flexible bit truncation setting is determined for at least one of the one or more processing layers. A flexible bit truncation setting can be substantially equal to one or more other truncation settings, or can be substantially different from other truncation settings. The determining is based on an application to be executed on the machine learning network. Different applications can process different data types, data precisions, and the like. Thus, bit truncation settings can differ between applications, data types to be processed by the applications, etc. The flexible bit truncation setting is programmed in the flexible bit truncation storage hardware of the at least one of the one or more processing layers. The programming the flexible bit truncation setting can occur in real time during application runtime. The truncation setting need not remain static throughout processing by the application. The programming the flexible bit truncation setting can change dynamically during runtime. The application is executed using the flexible bit truncation setting. The execution can produce a result such as a classification or an inference.

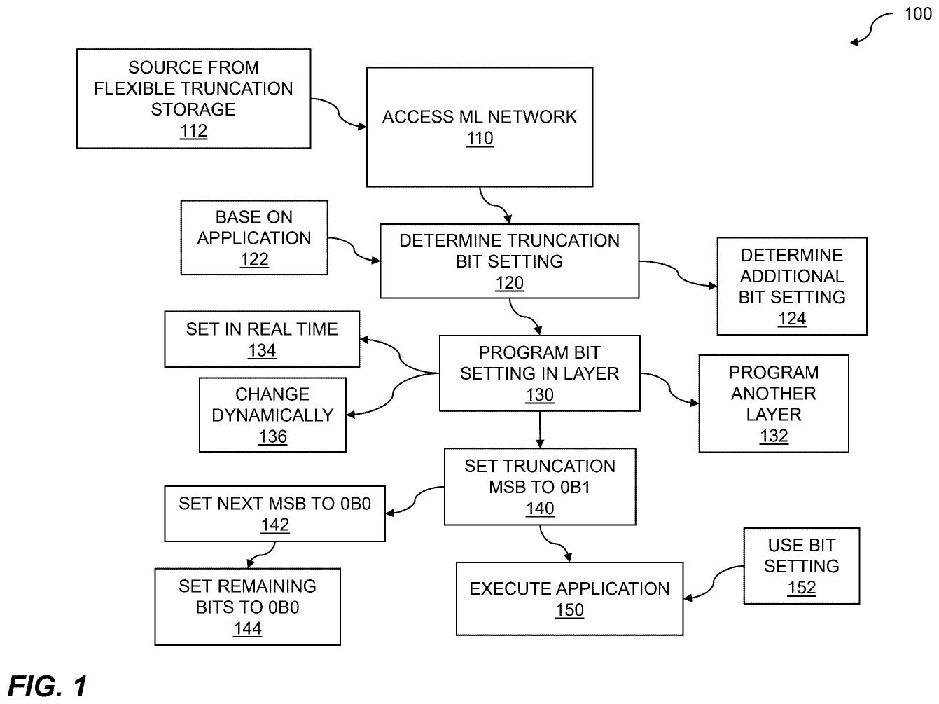

FIG. 1 is a flow diagram for machine learning processing using flexible bit truncation. Data can be sourced from storage and processed by an application running on a network such as a machine learning network. The data that is processed can include collected data; media data such as audio data, image data, and video data; and so on. The data can be sourced from storage hardware, where the storage hardware includes flexible bit truncation storage hardware. The storage hardware can be programmed with a flexible bit truncation setting that is determined based on an application to be executed on the network. The flexible bit truncation setting can be determined for at least one layer within the machine learning network. The bits that are truncated, if any, include least significant bits (LSBs) of a data element. The number of LSBs that are truncated can be balanced between reducing data processing complexity and maintaining processing outcome accuracy. In addition to reducing processing complexity, the truncating LSBs can reduce power consumption by storage hardware and the processing layers of the ML network. The truncating data enables circuit elements associated with the LSBs to be deselected. The deselecting of circuit elements includes electrically decoupling circuitry associated with the LSBs. The decoupled LSBs are not accessed, so power to the LSBs is not required, thus reducing power consumption of the storage hardware.

The flow 100 includes accessing 110 a machine learning network. The machine learning network can be based on an artificial neural network (ANN), where the ANN can be configured for a variety of artificial intelligence (AI) network applications. Example AI network configurations can include a machine learning network, a deep learning network, and so on. The machine learning network can be based on a convolutional neural network (CNN). The machine learning network can include one or more processing layers. The processing layers can include an input layer, an output layer, one or more intermediate or hidden layers, and so on. The layers of the machine learning network can process a variety of data types. The data types can include audio data, image data, video data, etc. The data can be represented by various number representations such as integer data, single-precision floating point data, double-precision floating point data, etc. In a usage example, image data can include red-green-blue data (RGB) data represented by 8-bit pixels. In a second usage example, the data can be represented by 32-bit floating point values. The machine learning network can execute an application. The application can be based on an algorithm, a model, and the like. A model can be trained using training data, where the training data is labeled with expected classifications, inferences, etc. In the flow 100, at least one of the one or more processing layers is sourced 112 from flexible bit truncation storage hardware. The flexible bit truncation storage hardware can source data where the length of the data (e.g., the number of data bits) has been truncated. In embodiments, the flexible bit truncation storage hardware can include a static RAM (SRAM). The truncated data can include data with one or more least significant bits (LSBs) of data truncated. The flexible bit truncation storage hardware can be used to store various datatypes such as characters, symbols, numbers, and so on. The numbers can be written to and read from the storage hardware based on a variety of numeric representations.

The ML network can be trained and configured to execute an application. The application can include an audio processing application, an image processing application, a video processing application, a natural language processing application, and so on. The ML network can include one or more processing layers. A processing layer of the ML network can be sourced with the flexible bit truncation storage hardware. The number of LSBs truncated by the truncation storage hardware while sourcing the ML network can depend on the application that is executing. The number of bits that are truncated can include zero LSBs, one LSB, and so on. That is, the data that is sourced can remain untruncated or can be truncated. In embodiments, at least two of the one or more processing layers can be sourced with flexible bit truncation storage hardware. The number of LSBs that are truncated can be based on a setting (described below). The settings for each layer can be substantially similar or substantially dissimilar.

The flow 100 includes determining a flexible bit truncation setting 120 for the at least one of the one or more processing layers. More than one layer of the ML network can receive truncated data. In embodiments, at least two of the one or more processing layers are sourced with flexible bit truncation storage hardware. The processing layers can be processing substantially similar data types or different data types. The flexible bit truncation setting can include truncating zero LSBs, one LSB, two LSBs, and so on. In the flow 100, the determining is based on an application 122 to be executed on the machine learning network. The application to be executed can include an image or audio processing application, a natural language processing application, a video processing application, and so on. The determining can be based on analysis, where analysis results can be compared to a factor, a criterion, a threshold, and so on. The factor, criterion, threshold, etc. can include a convergence rate, a classification accuracy, an accuracy threshold, etc. In a usage example, a convolutional neural network model such as a VGG-16 model can be compared to a lightweight model such as a filter-pruned lightweight VGG-16 model. The models can be evaluated for different numbers of truncation bits, and the results compared for classification accuracy, inference convergence rate, etc. The flow 100 further includes determining at least one additional flexible bit truncation setting 124. The flexible bit truncation setting, and the additional flexible bit truncation setting, can be applied to different layers within the machine learning network. In embodiments, the at least one additional flexible bit truncation setting can be different from the flexible bit truncation setting. The flexible bit truncation setting can be used as determined, modified, and so on.

The flow 100 includes programming 130 the flexible bit truncation setting in the flexible bit truncation storage hardware of the at least one of the one or more processing layers. The programming the flexible bit truncation setting can include configuring the storage hardware to provide data less the truncated bits. The programming the flexible bit truncation setting can include providing the truncation setting to a truncation manager. The truncation manager can control one or more truncation elements, where a truncation element can enable or disable one or more LSBs in the bit truncation storage hardware. The truncation manager can further select which storage outputs will be sourced to the layer in the ML network. The flow 100 further includes programming the at least one additional flexible bit truncation setting in another of the one or more processing layers 132. Discussed above, the flexible bit truncation setting, and the additional flexible truncation setting, can be substantially similar or substantially dissimilar. The programming can occur at a convenient point in application execution on the machine learning network. In the flow 100, the programming the flexible bit truncation setting can occur in real time 134 during application runtime. As the application is executed on the machine learning network, requirements such as data precision requirements, classification accuracy, etc. can change. The changes can be applied to one or more layers within the machine learning network. In the flow 100, the programming the flexible bit truncation setting can change dynamically 136 during runtime. The dynamic change during runtime can occur for processing efficiency, relaxed precision requirements, etc.

In addition to reducing processing complexity while maintaining sufficient data classification, inference convergence, and so on, truncating data can be used to control power consumption, to reduce heat dissipation, etc. within the machine learning network. The programming can disable one or more current paths in a truncated portion of the flexible bit truncation storage hardware. In a usage example, three LSBs are truncated form data. Since the truncated LSBs will not be used to load (read) data from the storage element, the bitlines associated with the truncated LSBs do not need to be precharged. When bitlines are not precharged, power consumption by the flexible bit storage hardware is reduced. Heat dissipation by the storage hardware is also reduced. The powering bitlines and the precharging (nor not precharging) bitlines can be accomplished by selectively distributing power along each of the bitlines. The distributing is accomplished by coupling bitline power header devices to each of the bitlines. The bitlines can include the true bitlines and the complement bitlines. Recall that power can be distributed to bitlines prior to loading data from RAM elements within the flexible bit truncation storage hardware. In embodiments, the flexible bit truncation storage hardware can include a static RAM (SRAM). The power is distributed such that when the contents of storage hardware are enabled to the bitlines via pass transistors associated with the RAM elements (e.g., SRAM cells), the voltage on the bitlines, bitline true and bitline complement, are slightly disturbed in opposite directions. That is, the voltage on one bitline rises while the voltage on the other bitline drops. When designed properly, the contents of the SRAM cells recover when the SRAM cell is disconnected from the bitlines. Power can be distributed to the bitlines, or not when the bitlines are selectively decoupled by the truncation manager, using pullup devices and pulldown devices. In embodiments, the power header devices can include a power header device pair. The pullup devices can include p-type devices such as PMOS devices, while the pulldown devices can include n-type devices such as NMOS devices. The PMOS device and the NMOS device can comprise a power header device pair. In embodiments, a p-type power header device of the power header device pair can control source current power distribution for the bitline. In other embodiments, an n-type power header device of the power header device pair can control sink current power distribution for the bitline.

The flow 100 further includes setting a most significant bit (MSB) 140 of a truncated portion of the flexible bit truncation storage hardware to a 0b1 value. The setting the MSB to 0b1, and the setting of the remaining, truncated LSBs (discussed next), can accomplish setting the MSB of the LSBs to its mean value. The setting to the mean value can minimize expected mean square error (MSE) for computations. The flow 100 further includes setting a next most significant bit 142 of a truncated portion of the flexible bit truncation storage hardware to a 0b0 value. The setting of truncated LSBs can continue for the remaining yet unset LSBs. The flow 100 further includes setting the rest of the bits 144 of a truncated portion of the flexible bit truncation storage hardware to a 0b0 value. The setting the MSB of the LSBs to 0b1, and the remaining LSBs to 0b0, form the mean value of the truncated bits.

The flow 100 includes executing 150 the application. Note that the application that is being executed can include a data processing application. The application can include an audio processing application, an image processing application, a video processing application, and so on. The application can further include a trained machine learning application, a natural language processing application, etc. The flow 100 can further include using the flexible bit truncation setting 152. The application can be executed based on the one or more flexible bit truncation settings that were determined. In embodiments, the executing can include using the at least one additional flexible bit truncation setting. As the application is executing, a classification determined, an inference drawn, and the like, outputs such as outputs from a processing layer can be used to adjust the flexible bit truncation setting for one or more layers of the machine learning network. The adjustment of the setting can be based on a need for increased precision (e.g., fewer truncated LSBs), a processing task that dictates decreased precision (e.g., more truncated LSBs), and so on. Thus, in embodiments, the programming the flexible bit truncation setting can change dynamically during runtime.

In embodiments, the accessing, the determining, the programming, and the executing can include machine learning truncated inference. Artificial intelligence (AI) models such as machine learning models can be based on a tree-type structure called a decision tree. The decision tree is a technique that enables a model to make fast, simple decisions about data. The tree includes decision points and branches. Terminal branches are called leaves. The decision associated with the decision point can be made based on a “yes or no” decision, a value, a probability, and so on. In a usage example, an image includes a dog. At the decision point, “Does the image contain a dog?” the answer can be “yes” or “no.” If yes, then one branch is taken, potentially to further refine the decision-making process. If no, the other branch is taken. The other branch can be a terminal branch (e.g., a leaf) or can lead to further decision such as, “Does the image contain a cat?” Further answers to the decision can include “maybe” (e.g., not clearly yes or no), “maybe not,” etc. As a result, the decision tree can quickly become large and unwieldy, resulting in complex processing. To better control the size of the decision tree, the tree can undergo “truncation” and “pruning.” Truncation is a technique that can stop the increase of the size of the decision tree. Truncation can be used to reduce a tendency of the decision tree to overfit the data it is being used to process. In a usage example, images are examined to detect the presence or absence of a dog. If a dog is present, then further decisions might determine a size, color, breed, etc. of the dog. If the dog is not present, and the object is to find images with dogs, then further decisions that might reveal that an animal in an image is a horse are irrelevant. Pruning, on the other hand, is a technique that can be used to remove branches of the decision tree, starting from the farthest branches or “leaves” of the tree and working back up toward the root of the decision tree. Deciding which branches to prune can be based on application of appropriate datasets to the decision tree. The appropriate datasets can include a training dataset, a validation dataset, and a test dataset. The pruning can be based on proposing to prune a branch and calculating a metric such as an accuracy metric, a classification metric, a convergence rate metric, etc. The metric can be calculated for the performance of the decision tree before pruning and after pruning. If the metric meets a specified threshold after pruning, then the branch can be pruned. If the metric does not meet the specified threshold, the branch is not pruned. The pruning technique can be repeated as necessary to balance the reduction of decision tree size while maintaining one or more desired metrics. The truncation and the pruning enable machine learning truncated inference.

Recall that a variety of applications can be executed on the machine learning network. Each application or type of application can require different truncation settings. To determine truncation settings for an application, the execution of the application can be analyzed. Further embodiments can include analyzing the application for one or more flexible bit truncation settings. The one or more flexible bit truncation settings can be calculated, estimated, predicted, and so on. The results of analysis of applications and the truncation settings associated with the applications can be compared. In embodiments, the analyzing is based on application layer execution accuracy. The execution accuracy, such as classification accuracy, can be determined for zero truncation bits, one truncation bit, two or more truncation bits, etc. The determined execution accuracy can be compared to a value, a threshold, a percentage, etc. In embodiments, the analyzing can be based on application final result accuracy. The final result accuracy can include a classification accuracy, rate of convergence for an inference, and the like. In embodiments, the analyzing can include machine learning truncated training pruning. Discussed previously, a decision tree associated with the application can be pruned based on the application final result accuracy.

One benefit of the analysis of applications is that the applications can be grouped based on analyzed application type, application performance, truncation bit settings, and so on. Further, when a new application is introduced, analysis of previous applications of a similar or related type can be used to guide machine learning network settings such as one or more flexible bit truncation settings. In embodiments, the analyzing is catalogued into a generic application type. An example generic application type can include an audio application type, a video application type, a natural language type, etc. In embodiments, the generic application type can be stored in a catalog. The catalog can include one or more generic application types. In embodiments, entries in the catalog are used as a proxy analysis for an unanalyzed application type. The entries in the catalog can provide initial settings such as truncation bit settings for the unanalyzed application type. The catalog can include one or more entries for a variety of application types. In embodiments, the entries in the catalog can include image analysis, deep neural network processing, or generative artificial intelligence. The entries can further include generative adversarial network (GAN) entries.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

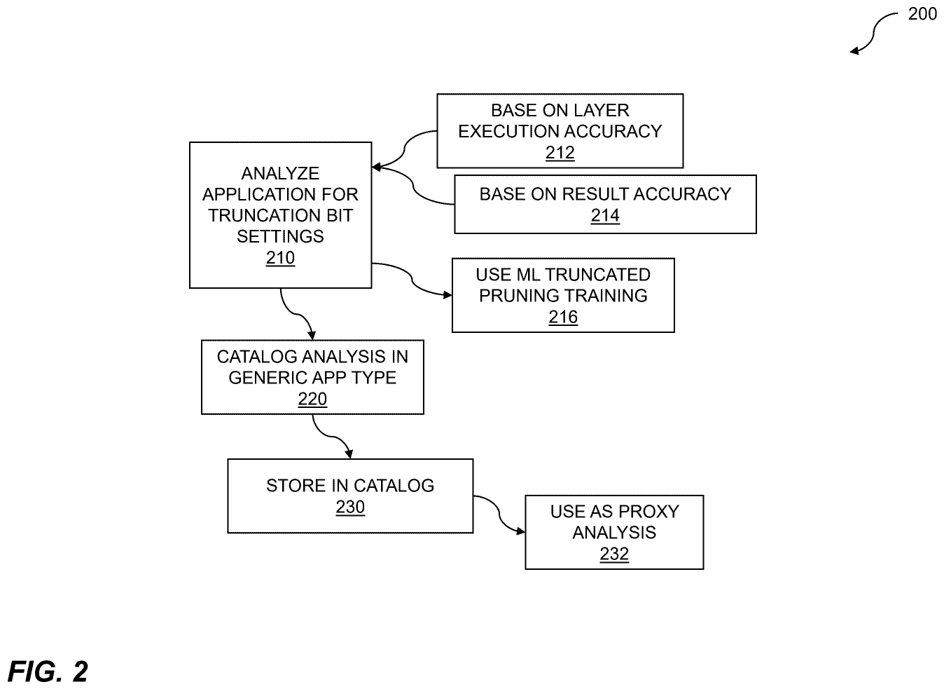

FIG. 2 is a flow diagram for application cataloging. A variety of applications can be executed on a machine learning network. The applications can include data processing applications such as audio processing, image processing, video processing, natural language processing, and so on. Thus, the data that is processed can include audio data, image data, video data, numeric data, among other types of data. Since a machine learning (ML) network is typically capable of executing more than one application, the applications that are executed can be analyzed and cataloged. The results of the analysis and cataloging can include identifying a “type” of application. An application type can include an audio processing application type, an image processing application type, etc. An application can be executed using flexible bit truncation based on determining a flexible bit truncation setting. When a new application is introduced to the ML network, the new application can be analyzed to determine its application type. By comparing the new application type to previously analyzed application types in a catalog, an appropriate flexible bit truncation setting may be found that can be used for the new application. The flexible bit truncation setting can be directly applicable to the new application, used as a starting point for bit truncation, and so on. Application cataloging enables machine learning processing using flexible bit truncation. A machine learning network is accessed. The machine learning network includes one or more processing layers, and at least one of the one or more processing layers is sourced with flexible bit truncation storage hardware. A flexible bit truncation setting is determined for the at least one of the one or more processing layers. The determining is based on an application to be executed on the machine learning network. The flexible bit truncation setting is programmed in the flexible bit truncation storage hardware of the at least one of the one or more processing layers. The application is executed using the flexible bit truncation setting.

The figure shows a flow for application cataloging. The flow 200 can include analyzing the application 210 for one or more flexible bit truncation settings. The flexible bit truncation settings can be applied to one or more layers within the machine learning network. The bit truncation settings can include truncating least significant bits. The settings can include truncating zero bits, one bit, two bits, and so on. The truncation settings can include settings that are based on processed data type, processing speed, and so on. The truncation bit settings can include a starting number of truncated bits, a best number of truncated bits, etc. The truncation settings can also be associated with reducing power consumption by the ML network. In the flow 200, the analyzing can be based on application layer execution accuracy 212. The execution can be based on an error such as mean square error (MSE). Discussed below, a number of LSBs can be truncated up to a maximum or threshold number of LSBs while still maintaining application layer execution accuracy. In further embodiments, the analyzing can be based on application final result accuracy 214. The final result accuracy can be based on data classification accuracy, inference accuracy, etc. In other embodiments, the analyzing can include machine learning truncated training pruning 216. Discussed further below, an algorithm such as an ML algorithm can be executed on the ML network. The algorithm can be represented by a decision tree, where a decision at a node can cause execution to precede along a branch of the tree. Branches of the tree can be truncated or “pruned” without affecting execution outcomes. The pruning can be determined based on execution analysis.

In the flow 200, the analyzing can be catalogued 220 into a generic application type. The generic application type can be used to group applications that are similar in that they can process the same data type. A data type can include audio data, image data, video data, numeric data, and so on. In a usage example, the analyzing can identify two image processing applications as being members of a generic image processing application type. Other categories can be included in the catalog. In embodiments, the entries in the catalog can include image analysis, deep neural network processing, or generative artificial intelligence. Generic application categories can be identified for applications that process other data types. In a usage example, the analyzing can identify two other applications as being members of a generic natural language processing application type. In the flow 200, the generic application type is stored in a catalog 230. The catalog can store generic application types such as the audio types, video types, etc. discussed above. The catalog can be used to store flexible bit truncation settings appropriate to an application type. The catalog can further store generic application types by processing resource requirements, processing speed, etc. The catalog can also store application types based on power consumption, heat dissipation, etc. In the flow 200, entries in the catalog can be used as a proxy analysis for an unanalyzed application type 232. In a usage example, an image processing application is obtained for execution on the ML network. The catalog can be searched or accessed to settings such as flexible bit truncation settings that can be applied to the unanalyzed image processing application. The settings can also be used as “starting point” settings for the application prior to analysis of the application.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

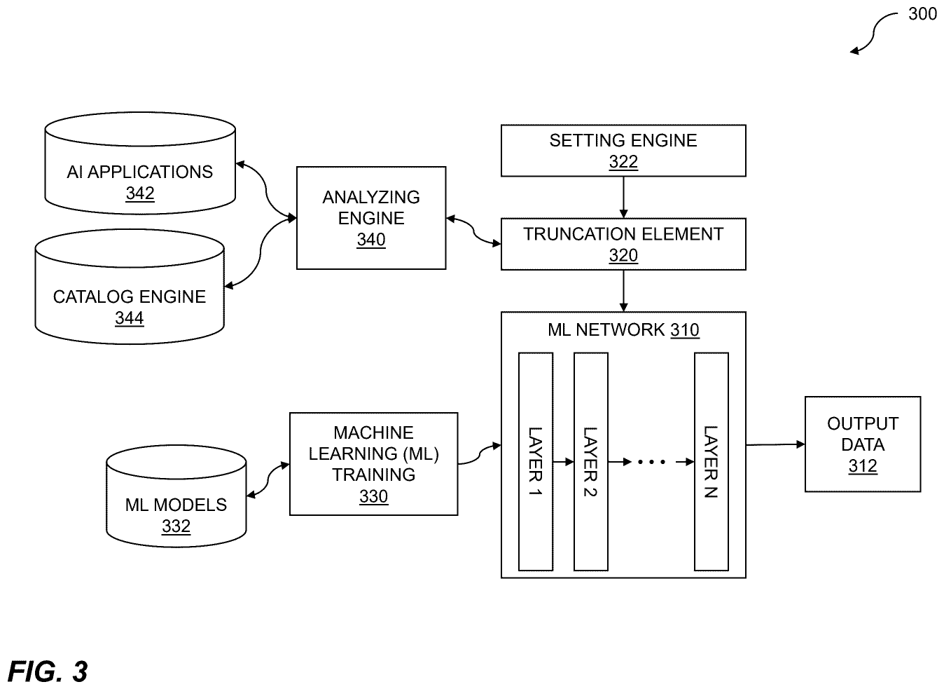

FIG. 3 is a system block diagram for machine learning using flexible bit truncation. Discussed previously and throughout, a flexible bit setting can be used to program flexible bit truncation hardware. The hardware can be used to source data to one or more layers within a machine learning network. The use of flexible bit truncation enables machine learning processing. A machine learning network is accessed. The machine learning network includes one or more processing layers, and at least one of the one or more processing layers is sourced with flexible bit truncation storage hardware. A flexible bit truncation setting is determined for the at least one of the one or more processing layers. The determining is based on an application to be executed on the machine learning network. The flexible bit truncation setting is programmed in the flexible bit truncation storage hardware of the at least one of the one or more processing layers. The application is executed using the flexible bit truncation setting.

The system block diagram 300 includes a machine learning (ML) network 310. The machine learning network can be based on a neural network configured for machine learning. The ML network can include processing layers, such as layer 1, layer 2, and layer N. While three layers are shown, other numbers of layers can be included in the ML network. The layers can include an input layer, an output layer, one or more intermediate or hidden layers, and so on. One or more of the hidden layers can include convolutional layers, activation layers, pooling layers, and so on. The machine learning network can be configured as a convolutional network. The ML network can produce output data 312. The output data can include a classification, an inference, and the like. The ML network can receive or be sourced input data. In embodiments, at least one of the one or more processing layers is sourced with flexible bit truncation storage hardware. In the system block diagram 300, the sourcing the flexible bit truncation data can be accomplished using a truncation element 320. The truncation element can be controlled by a truncation manager (not shown). The truncation element can truncate least significant bits (LSB) of a data element. The truncation element can truncate zero bits, one bit, two bits, and so on. The number of bits to truncate can be set. The system block diagram 300 can include a setting engine 322. The setting engine can be used to determine a flexible bit truncation setting for the at least one of the one or more processing layers. The determining can be based on a variety of factors. In embodiments, the determining can be based on an application to be executed on the machine learning network. The application can include a data processing application such as an audio application, an image application, a video application, a natural language application, etc. The setting engine can determine more than a flexible bit truncation setting. Any additional settings can be determined for one or more additional layers within the ML network.

The system block diagram 300 can include a machine learning training element 330. The ML machine training element can be used to configure or train the ML network. The ML training element can begin training the ML network by selecting an ML model. The ML model can be selected from a plurality of ML models 332. The selected ML model can be adjusted for a particular application that can be executed on the ML network. The training the ML model can be accomplished by applying datasets to the ML model. The training dataset can include a training dataset, a validation dataset, and a test dataset. The dataset can be used to configure weights, biases, etc. associated with the ML model.

The ML network can be configured to execute a variety of AI applications, as discussed previously. Some of the AI applications can be similar, such as AI applications that can be executed to classify image data. As a result, some AI application-related configurations of the ML network can be reused, used as starting points for configuring the ML network, and so on. Determining which applications can be similar and which are not can be determined by analysis of the applications. In the system block diagram 300, the analyzing can be accomplished by an analyzing engine 340. The analyzing can be used to determine flexible bit truncation settings. Further embodiments can include analyzing an application for one or more flexible bit truncation settings. The one or more flexible bit truncation settings can be associated with one or more layers within the ML network. The bit truncations settings can include settings for classification accuracy, inference efficiency (e.g., convergence rate), and the like. The applications that are analyzed can include a library or other repository of AI applications 342. Various criteria, factors, metrics, and so on can be bases for application analysis. In embodiments, the analyzing can be based on application layer execution accuracy. The accuracy can be based on absolute values, tolerances, etc. In other embodiments, the analyzing can be based on application final result accuracy. The final result accuracy can be associated with classification accuracy or other criteria. The results of the analyzing can be stored. In embodiments, the analyzing can be catalogued into a generic application type. The generic application type can include an image processing time, a video processing type, and the like. In, embodiments, the generic application type can be stored in a catalog. In the system block diagram 300, the cataloging generic application types can be accomplished by a catalog engine 344. When a new AI application is introduced for execution on the ML network, the new AI application can be compared to one or more generic application types in the catalog. If a match is found, the previously determined settings can be used for the ML network, used as a starting point for configuring the ML network, etc.

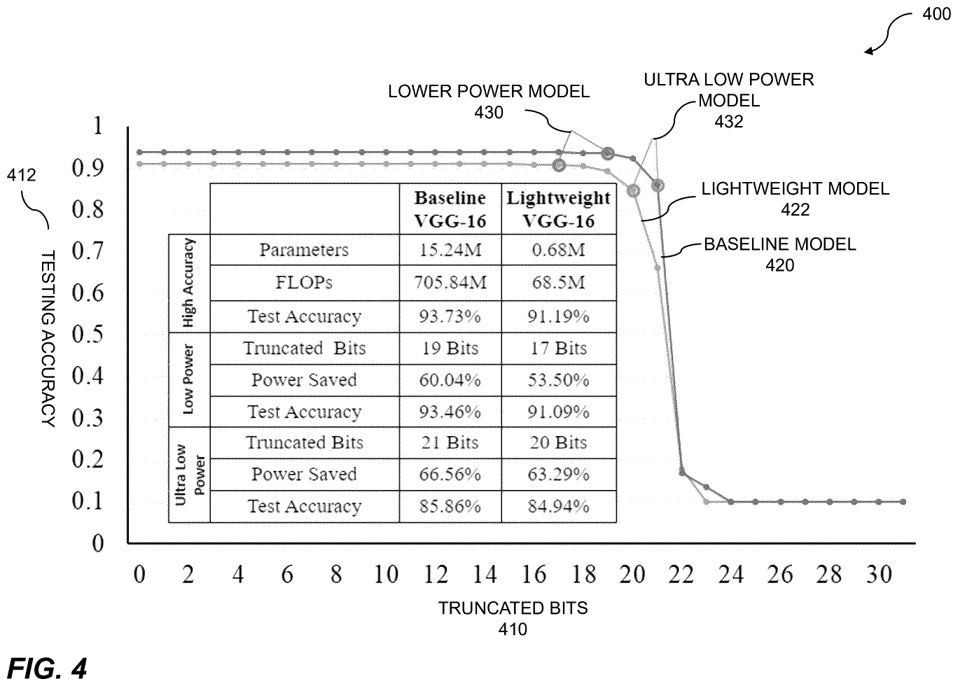

FIG. 4 is a plot showing performance of deep learning using flexible bit truncation. Noted previously, one or more least significant bits (LSBs) can be truncated from a data element. The truncation of the data can enable faster computations, and as side benefits, reduced power consumption and heat dissipation by the processing layers of a machine learning network. However, as fewer data bits are processed by the machine learning (ML) network, there is a potential for results produced by the ML network to be less accurate or reliable. The plot of performance of the ML network shows testing accuracy for flexible numbers of truncated bits. The flexible bit truncation enables machine learning processing. A machine learning network is accessed. The machine learning network includes one or more processing layers, and at least one of the one or more processing layers is sourced with flexible bit truncation storage hardware. A flexible bit truncation setting is determined for the at least one of the one or more processing layers. The determining is based on an application to be executed on the machine learning network. The flexible bit truncation setting is programmed in the flexible bit truncation storage hardware of the at least one of the one or more processing layers. The application is executed using the flexible bit truncation setting.

The plot 400 shows testing accuracy 412 versus flexible numbers of truncated bits 410 for different models. The plot shows that testing accuracy remains relatively constant until the number of truncated bits exceeds a number of bits such as 20 bits. Testing accuracy is shown for two models, a baseline model 420 and a lightweight model 422. The baseline model can include a deep neural network (DNN) model such as a VGG-16 model. The lightweight model can include a pruned version of the baseline model. The baseline model can be trained using different numbers of epochs, where an epoch can include processing an entire training dataset through a model. One entire dataset processing model is one epoch. The lightweight model was pruned to differing percentages. The results of the training are shown. Recall that power consumption by the ML network can be reduced by the flexible truncation of LSBs. The flexible bit truncation can be applied to the storage of weights associated with layers of the ML network in order to track power reduction. A lower power model 430 is shown, where the lower power model was based on bit truncations such as a 19-bit truncation and a 17-bit truncation. The ultra low power model 432 can be based on more aggressive bit truncation.

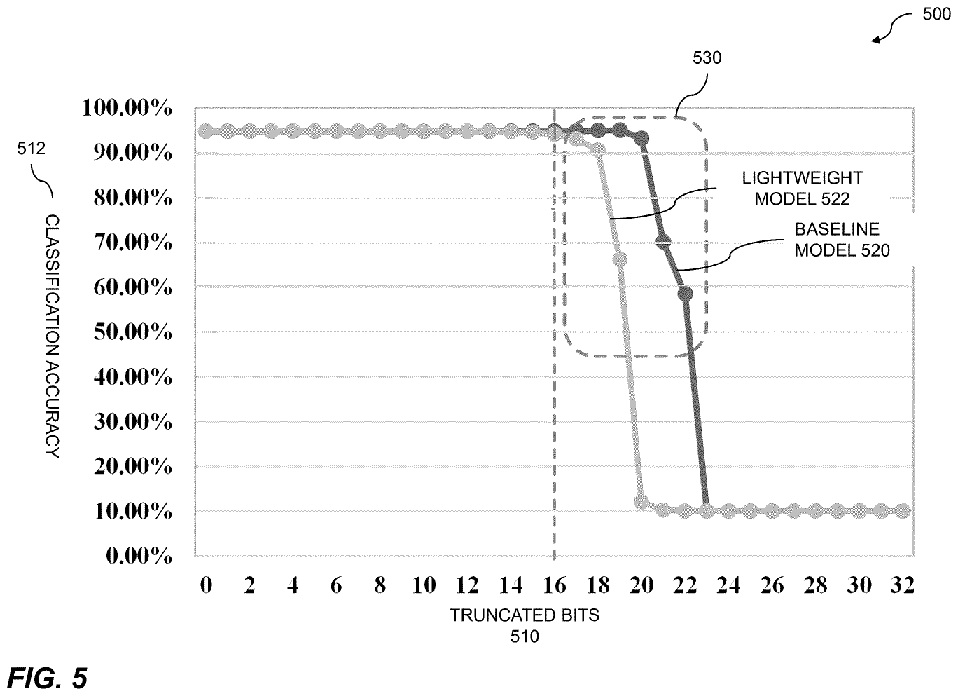

FIG. 5 shows classification accuracy of a convolutional neural network (CNN) with different truncation bits and values. Bit truncation can be applied to processing by a machine learning (ML) network. The ML network can be based on a CNN. As the numbers of bits such as least significant bits (LSBs) that are truncated increases, the accuracy of the processing of the data can decrease. The accuracy can include classification accuracy, where classification is based on determining whether a data element is a member of a class or not a member of the class. Classification accuracy is enabled by machine learning processing using flexible bit truncation. A machine learning network is accessed. The machine learning network includes one or more processing layers, and at least one of the one or more processing layers is sourced with flexible bit truncation storage hardware. A flexible bit truncation setting is determined for the at least one of the one or more processing layers. The determining is based on an application to be executed on the machine learning network. The flexible bit truncation setting is programmed in the flexible bit truncation storage hardware of the at least one of the one or more processing layers. The application is executed using the flexible bit truncation setting.

The FIG. 500 shows classification accuracy 512 plotted against number of truncated bits 510. Flexible bit truncation has been discussed for applications such as machine learning (ML) processing. The flexible bit truncation can be used to reduce computational complexity while maintaining processing accuracy. The processing accuracy can be associated with classification accuracy, inference accuracy, and so on. The data that is processed by the ML network can be sourced from storage such as flexible bit truncation storage hardware. The flexible bit truncation storage hardware can be controlled by truncation elements, which can in turn be controlled by a truncation manager. The flexible bit truncation can adapt the number of truncated bits to be sourced to layers within the ML network. A number of truncated bits can be determined, calculated, estimated, etc. The number of truncated bits can be chosen based on the type of data that is being processed. In a usage example, the data can include 8-bit integer pixel values associated with video data. The truncated LSBs can be set to a value such as 0b10 . . . 0 which is the mean value. The mean value for the truncated bits can reduce or minimize expected mean square error (MSE). In another usage example, the data can include floating point numbers. The floating point numbers can be based on the IEEE 754 single-precision floating point representation. Of the three fields associated with the floating point numbers, the 1-bit sign, the 8-bit exponent, and the 23-bit mantissa, LSBs associated with the mantissa can be truncated.

The figure shows performance of a deep neural network (DNN) for machine learning. The DNN can include a network such as an AlexNet convolutional neural network (CNN). The DNN can be trained and tested with a dataset such as the CIFAR-10 dataset. The CIFAR-10 dataset includes training images and test images. The performance of the DNN can be plotted. The figure shows classification accuracy 512 versus number of truncated bits 510 for varying numbers of truncated bits 510 that can be plotted. The classification performance is plotted for two different truncation techniques, a baseline model 520 and a lightweight model 522. The baseline model can include a deep neural network (DNN) model such as an AlexNet CNN model. As discussed previously, the lightweight model can include a pruned version of the baseline model. The baseline model can be trained using a dataset such as the CIFAR-10 dataset training images and tested using the CIFAR-10 test images. The training can occur over various numbers of epochs, where an epoch describes processing the entire training dataset through a model. The classification results for increasing numbers of truncated bits are plotted. Recall that an important benefit of the flexible bit truncation is that power consumption by the DNN can be decreased as the number of truncated bits increases. The figure shows accuracy to power tradeoffs for the baseline model and the lightweight model as the number of truncated bits increases as highlighted by region of interest 530.

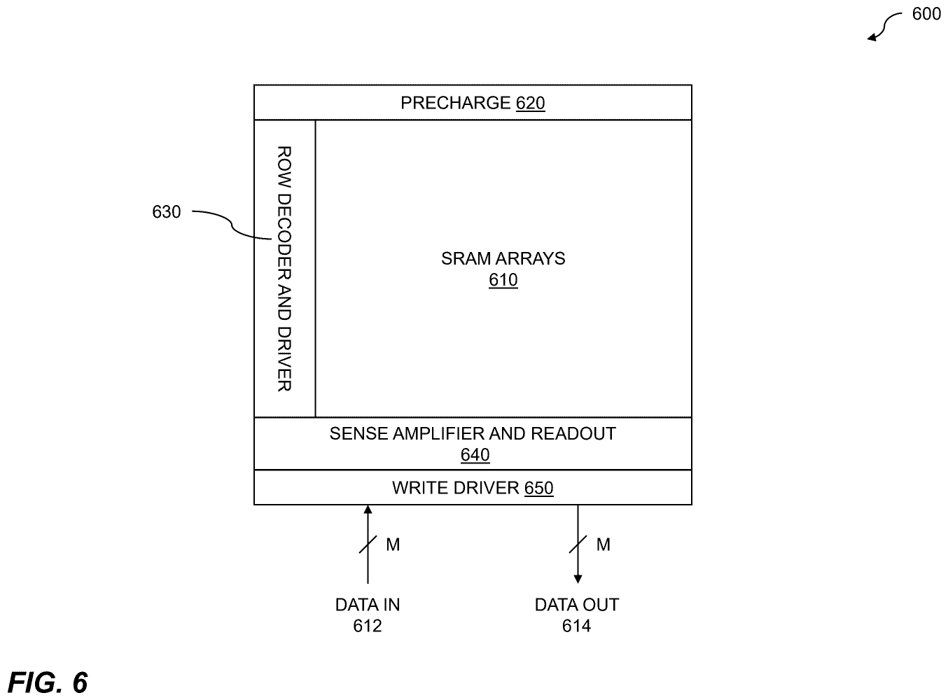

FIG. 6 is a system block diagram showing truncation management and power gating. The memory structure can comprise a static RAM (SRAM). The SRAM can include flexible bit truncation capabilities. The SRAM can be embedded with or have access to processing logic on a chip, can comprise a standalone device, can be stacked with a logic chip or additional memory chips in a separate package, and so on. The SRAM can be coupled to a machine learning network. The SRAM can enable machine learning processing using flexible bit truncation. A machine learning network is accessed. The machine learning network includes one or more processing layers, and at least one of the one or more processing layers is sourced with flexible bit truncation storage hardware. A flexible bit truncation setting is determined for the at least one of the one or more processing layers. The determining is based on an application to be executed on the machine learning network. The flexible bit truncation setting is programmed in the flexible bit truncation storage hardware of the at least one of the one or more processing layers. The application is executed using the flexible bit truncation setting.

The system block diagram 600 includes SRAM arrays 610. The SRAM arrays 610 can be based on various circuit topologies. In a usage example, the SRAM arrays are based on six-transistor SRAM cells. The SRAM arrays can have access to data input lines such as data in 612. The data input lines can provide data to the SRAM arrays for storing the data in the SRAM arrays. The data input lines can include M data input lines. The SRAM arrays can have access to data output lines such as data out 614. The data output lines can be used to load (read) data from the SRAM arrays and provide that data at the outputs of the SRAM. The data output lines can include M data output lines. The data in and data out lines can be unidirectional or bidirectional. The system block diagram 600 can include precharge 620. Precharge can be used to set a voltage on bitlines of the SRAM array. The set or “precharge” voltage is used to enable loading of contents of the SRAM to be accomplished faster and more reliably compared to not setting bitline voltages. In embodiments, the bitlines are precharged using bitline power header devices. The bitline power header devices can include a pair of devices, where one device can include a p-type device. The p-type device of the header pair can source current to a bitline. The other device of the header pair can include an n-type device. The n-type device can sink current from a bitline.

The system block diagram 600 can include row decoders and row drivers 630. The row decoders select one or more wordlines associated with the RAM array. The decoders receive an address, where the address can include a number of bits such as N bits. The selected wordline or wordlines enable access to RAM cells that are coupled to the one or more wordlines. The RAM cell access supports storing data on bitlines into the RAM cells, and loading data stored in the RAM cells onto bitlines. The row drivers energize a wordline or wordlines selected by the decoder. The drivers speed transmission of a selection signal along a wordline. The system block diagram can include sense amplifiers and readout logic. A sense amplifier detects a small signal change such as a small voltage change on at least one bitline. Based on the direction of the small signal change, such as an increase or a decrease in voltage, the sense amplifier amplifies the small signal change to quickly indicate a value read from a RAM cell. A sense amplifier can access both the true bitline and the complement bitline associated with a RAM cell. Such a sense amplifier differentially reads the true bitline and the complement bitline, thereby speeding up the determination of the contents of the RAM cell. In a usage example, a precharge voltage is placed on a true bitline and on a complement bitline associated with a RAM cell. A RAM cell is selected using a wordline. The precharge voltage on the true bit changes slightly either up or down. The precharge voltage on the complement bitline changes in a direction opposite of the change of the true bitline. The resulting voltage differential enables the sense amplifier to quickly change from the slight voltage changes to a full voltage swing on the bitlines.

Continuing with block 640, the block includes a readout capability. In embodiments, the readout capability is enabled by bitline output multiplexers, where the bitline output multiplexors selectively couple the bitlines to data outputs. A multiplexer can select from a plurality of bitlines and direct the selected bitline value to a data output line of the RAM. The plurality of multiplexers can be used to select a group of associated bits within RAM cells. The associated bits can include a byte, a half word, a word, a double word, and so on. The system block diagram 600 can include write drivers 650. The write drivers can be used to write data received on data input lines such as the data in lines 612 discussed above. The write drivers speed the storing of data into one or more RAM cells.

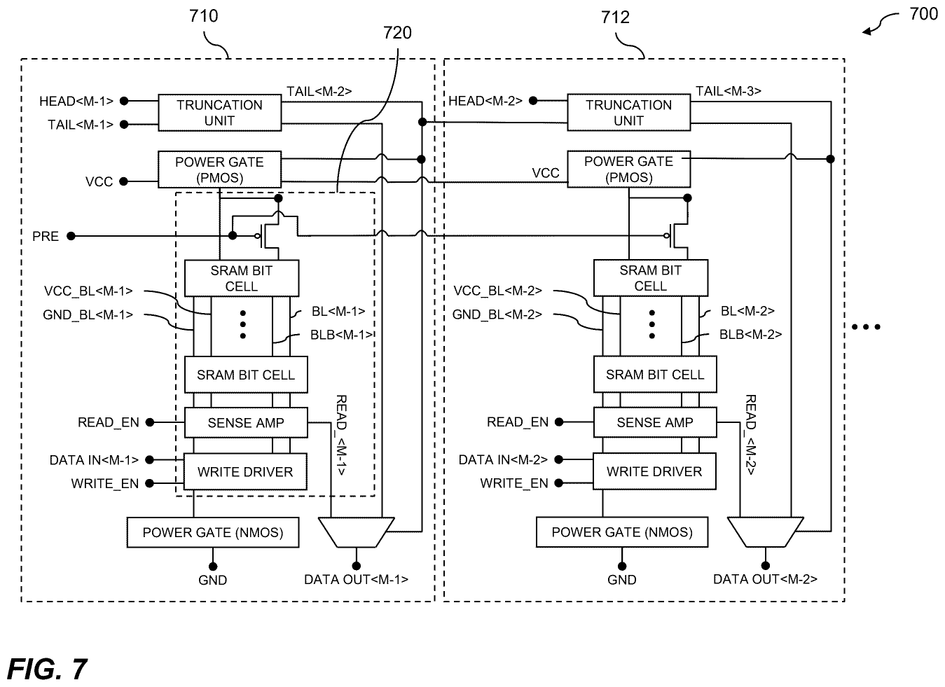

FIG. 7 shows an example memory structure. The memory structure shown in the system block diagram 700 can include a plurality of random access memory (RAM) cells. The RAM cells are arranged in columns, and the RAM cell columns are arranged in an array. The RAM cells can be static RAM cells (SRAM). The memory structure can further include precharge elements, row decoders and drivers, bitlines, sense amplifiers and readout multiplexers, write drivers, and so on. The memory structure can further include a truncation manager (not shown). The truncation manager can comprise a truncation unit disposed for controlling each bitline. The truncation manager can selectively control power distribution to each bitline within the RAM array. The truncation manager can further selectively couple the bitlines to data outputs. The selective coupling can be accomplished using multiplexers. The memory structure can be coupled to a machine learning network. The memory structure can support machine learning processing by sourcing the processing layers using flexible bit truncation storage hardware. A machine learning network is accessed. The machine learning network includes one or more processing layers. At least one of the one or more processing layers is sourced with flexible bit truncation storage hardware. A flexible bit truncation setting is determined for the at least one of the one or more processing layers. The determining is based on an application to be executed on the machine learning network. The flexible bit truncation setting is programmed in the flexible bit truncation storage hardware of the at least one of the one or more processing layers. The application is executed using the flexible bit truncation setting.

Discussed previously and throughout, least significant bits (LSBs) can be truncated from data as the data is written, stored, and read from a RAM such as a static RAM (SRAM). The LSBs of the data can be truncated in order that processing such as machine learning processing can be reduced while still accomplishing inferences such as classifications with sufficient accuracy. The reduction of the number of bits by truncation can further accomplish power consumption reduction by the machine learning network. In a usage example, one or more LSBs of the data can be truncated from data such as images, audio data, video data, and so on. The selection of the number of LSBs to truncate can be based on classification accuracy, inference convergence, etc. associated with identifying people, animals, objects, etc. within the data. The truncation can be accompanied by power gating to truncate LSBs and to reduce power consumption.

The system block diagram 700 shows a memory structure based on SRAM cell columns. While two columns of SRAM cells are shown, SRAM cell column 710 and SRAM cell column 712, other numbers of SRAM cell columns can be included. The “cell columns” can be based on SRAM cells coupled to common bitlines, and the logic circuits to support storing data into the SRAM cells and loading data from the SRAM cells. The common bitlines can include a true bitline and a complement bitline. The number of SRAM cell columns included in the memory structure can be based on a size of a data object such as a byte, a word, a double word, and so on. The number of SRAM cell columns can include a multiple of the size of the data object. An SRAM cell column such as 720 can include a precharge device, a plurality of SRAM bit cells, a sense amplifier, and a write driver. In order to enable the SRAM columns to support flexible bit truncation, additional logic elements can be added to the SRAM columns. In embodiments, a truncation logic unit is coupled to the SRAM cell column. The truncation logic unit can receive control signals from the truncation manager and from another SRAM column. The truncation logic unit can selectively control bitline power to the bitlines in the SRAM column. The selective control of bitline power can be accomplished using one or more power header devices. In embodiments, the power header devices can include a power header device pair. One device of the device pair can source current to the bitline from a source such as VCC. The other device of the device pair can sink current from the bitline to a “source” such as ground. In a usage example, the power header devices can selectively isolate the bitline from power distribution. The selectively isolating the power distribution can reduce power consumption by the SRAM cell column. The truncation logic unit can further selectively control bitline data output. In a usage example, the SRAM cell column is to be truncated. The data out can include a signal such as a tail signal indicating that no data is provided. If the SRAM cell column is not truncated, then the output comprises the data.

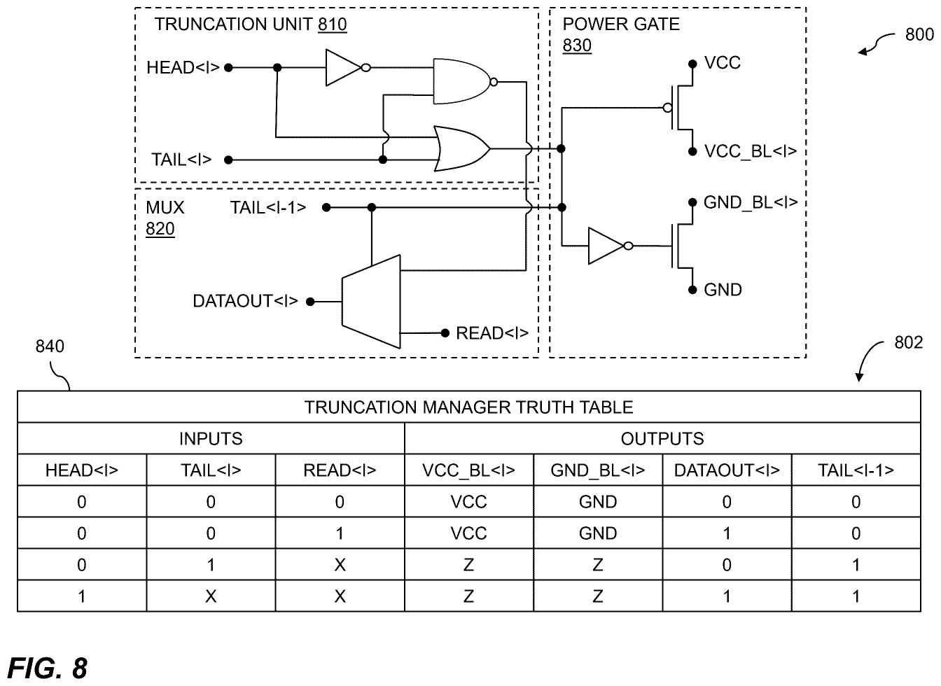

FIG. 8 illustrates truncation manager circuitry and a truth table. An element such as a truncation manager can be coupled to a random access memory (RAM). The truncation manager can truncate one or more least significant bits (LSBs) from data by selectively controlling bitline power to and bitline data output from the one or more least significant data bits. The data can include alphanumeric data, audio data, video data, and so on. The bitline power and bitline data output can be controlled in order to reduce the number of bits per data element processed by a machine learning network. The shorter data elements can be processed while still maintaining data classification accuracy, inference convergence, and so on. Selectively controlling bitline power and bitline data output further reduces RAM power consumption, RAM heat dissipation, and so on. The truth table shows inputs to and outputs from the truncation manager circuitry. The truncation manager circuitry and the truth table enable machine learning processing using flexible bit truncation. A machine learning network is accessed. The machine learning network includes one or more processing layers, and at least one of the one or more processing layers is sourced with flexible bit truncation storage hardware. A flexible bit truncation setting is determined for the at least one of the one or more processing layers. The determining is based on an application to be executed on the machine learning network. The flexible bit truncation setting is programmed in the flexible bit truncation storage hardware of the at least one of the one or more processing layers. The application is executed using the flexible bit truncation setting.

Truncation manager circuitry is shown 800. The truncation manager circuitry can control a bitline within the RAM array. The truncation manager controls three blocks that in turn access and control a bitline. These three blocks can be repeated for each bitline within the RAM. The three blocks can include a truncation logic unit 810. The truncation logic unit controls selective distribution of power along each of the bitlines. The truncation logic unit further controls bitline output selection. The truncation logic unit can receive as inputs a head value such as head<i>, and a tail value such as tail<i>. The truncation circuitry further includes a multiplexer 820 or “mux.” The multiplexer selectively couples the bitline to the data output. The multiplexer can be controlled by a tail bit such as tail<i−1>. The multiplexer selects between the output of the truncation logic unit, and a data bit loaded from the RAM. The output of the multiplexer is provided to an output line such as dataout<i>. The truncation manager circuit further includes a power gate 830. The power gate is also referred to throughout as the power header devices. In embodiments, the power header devices comprise a power header device pair. The power header device pair can include different or complementary devices such as a p-type device and an n-type device. In embodiments, the p-type power header device of the power header device pair can control source current power distribution for the bitline. The p-type device can act as a pullup device for the bitline. In other embodiments, the n-type power header device of the power header device pair can control sink current power distribution for the bitline. The n-type device can act as a pulldown device. The p-type device can be coupled between a high voltage such as VCC and the bitline. The n-type device can be coupled to the bitline and a low voltage such as ground.

The figure further shows a truth table 802 for the truncation manager circuitry. The truth table includes inputs and outputs 840. The truth table further shows possible values for inputs, and the resulting values for the outputs. The inputs to the truncation manager truth table can include a head signal such as head<i>. The head signal can be generated by the truncation manager. The inputs can further include a tail signal such as tail<i>. The tail signal can be provided by the truncation manager, can be received from a previous truncation logic unit, and so on. The inputs can further include a read signal such as read<i>. The read signal can be used by the multiplexer to select data read from the RAM of the output of the truncation logic unit. The truth table can include outputs such as bitline outputs, data out, and a tail output. The bitline outputs can indicate that a bitline is connected to VCC, such as vec_bl<i>. The bitline outputs can further indicate that a bitline is connected to ground such as gnd_bl<i>. The remaining outputs shown in the truth table can include data out and tail. Data out such as dataout<i> can include a tail output indication or data loaded from a RAM cell. The remaining output shown, tail such as tail<i−1>, can be provided to the next least significant bit in the data. The tail bit can be used to indicate that the next least LSB is to be truncated.

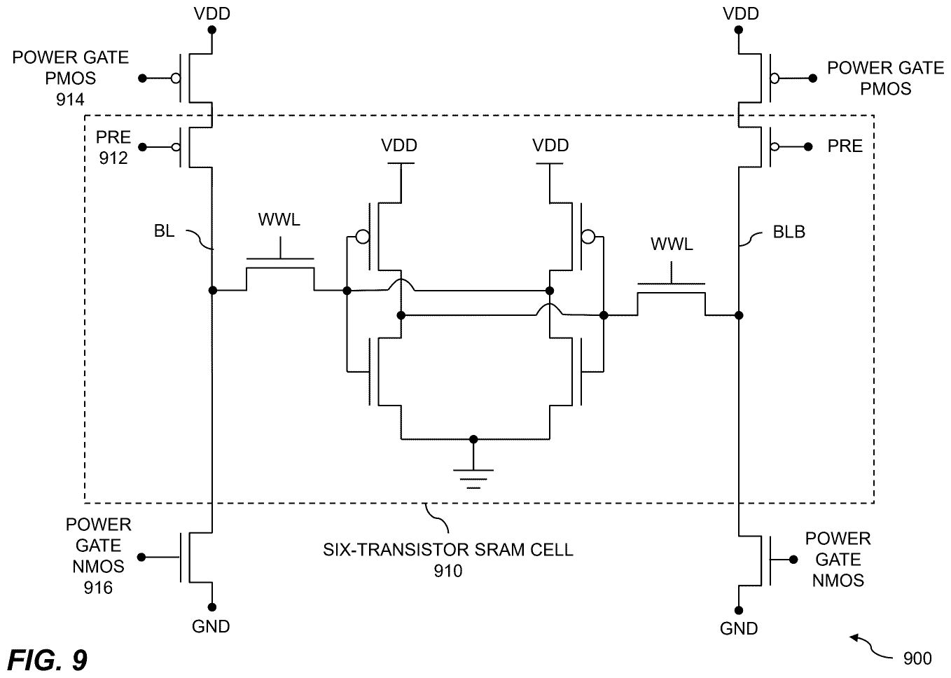

FIG. 9 shows an example six-transistor bit cell with power gates. A memory cell such as a RAM cell is based on a circuit topology. Discussed previously and throughout, the RAM cell can include a static RAM (SRAM) cell. The RAM cell can store data as a voltage, where a high voltage can represent a logical value such as a logic one, and a low voltage can represent another logical value such as a logic zero. In addition, the RAM can access one or more bitlines, where the bitlines can be used to store (write) data into the RAM and to load (read) data from the RAM. Access by the RAM to the bitlines is enabled by a word line. The RAM cell can be one of a plurality of RAM cells within an array that forms the RAM. The RAM is enabled using flexible bit truncation. The flexible bit truncation enables the RAM to source data for machine learning processing. A machine learning network is accessed. The machine learning network includes one or more processing layers, and at least one of the one or more processing layers is sourced with flexible bit truncation storage hardware. A flexible bit truncation setting is determined for the at least one of the one or more processing layers. The determining is based on an application to be executed on the machine learning network. The flexible bit truncation setting is programmed in the flexible bit truncation storage hardware of the at least one of the one or more processing layers. The application is executed using the flexible bit truncation setting.

A six-transistor RAM bit cell with power gates is shown 900. The bit cell can include a six-transistor RAM cell 910. The six-transistor (6T) RAM cell, such as the six-transistor SRAM cell shown, can be based on two cross-coupled inverters and two pass transistors. The cross-coupled inverters statically hold a logical value such as a logic one or a logic zero. The 6T bit cell with power gates (discussed below) can be used to store bits such as least significant bits (LSBs) of data, where the data can include a byte, a word, a double word, etc. The 6T SRAM cells can be fabricated in a variety of semiconductor technologies such as CMOS technologies. The CMOS technologies can be based on a range of feature sizes. A feature size associated with a CMOS technology can include a 50 nm feature size. The 6T cells can be controlled by write/read wordlines (WWLs). When the wordline is enabled, the contents of the 6T call can perturb a pair of bit lines. The bit lines can include a true bit line (BL) and a complemented or “barred” bit line (BLB). The bit lines of a 6T cell can be coupled to a differential sense amplifier (not shown) that can resolve the value of the contents of the 6T cell as a logic one value or a logic zero value. The transistors associated with the cross-coupled inverters and the transistors can be sized to increase read access speed, data integrity, and so on. In embodiments, the PMOS pullup (PU) devices of the cross-coupled inverters can include a shape factor (e.g., W/L) of 100 nm/50 nm. The NMOS pulldown (PD) devices associated with the inverters can include a shape factor of 200 nm/50 nm. The pass transistors that accomplish access to the 6T storage cells can include a shape factor of 150 nm/50 nm.

Prior to loading data from the SRAM cell, bitlines BT and BTB can be precharged to a precharge voltage. The precharge voltage can be chosen to minimize disturbance of the bit loaded into the RAM while maximizing effectiveness of the transfer of the bit value to the bitlines. Disturbance of the bit loaded into the RAM can include switching or inverting the contents of the RAM cell. Each bitline can be charged using a precharge device such as a PMOS device. The precharge signal such as pre 912 can be coupled to a bitline to precharge the bitline to the desired precharge voltage. Recall that one or more LSBs associated with data such as video data can be truncated. The truncating the LSBs simplifies processing by a machine learning network while maintaining data classification accuracy. Further, the truncating the LSBs reduces power consumption by the RAM. The truncating LSBs is accomplished using power header devices. The bitline power header devices can selectively distribute power along each of the bitlines. The power header devices can include PMOS devices, NMOS devices, and a combination of PMOS and NMOS devices. In embodiments, the power header devices can include a power header device pair. In the diagram, the power header device pair can include PMOS device 914 and NMOS device 916. In embodiments, the p-type power header device of the power header device pair can control source current power distribution for the bitline. The PMOS device 914 can be used as a pullup device. In other embodiments, the n-type power header device of the power header device pair can control sink current power distribution for the bitline. The NMOS device 916 can be used as a pulldown device.

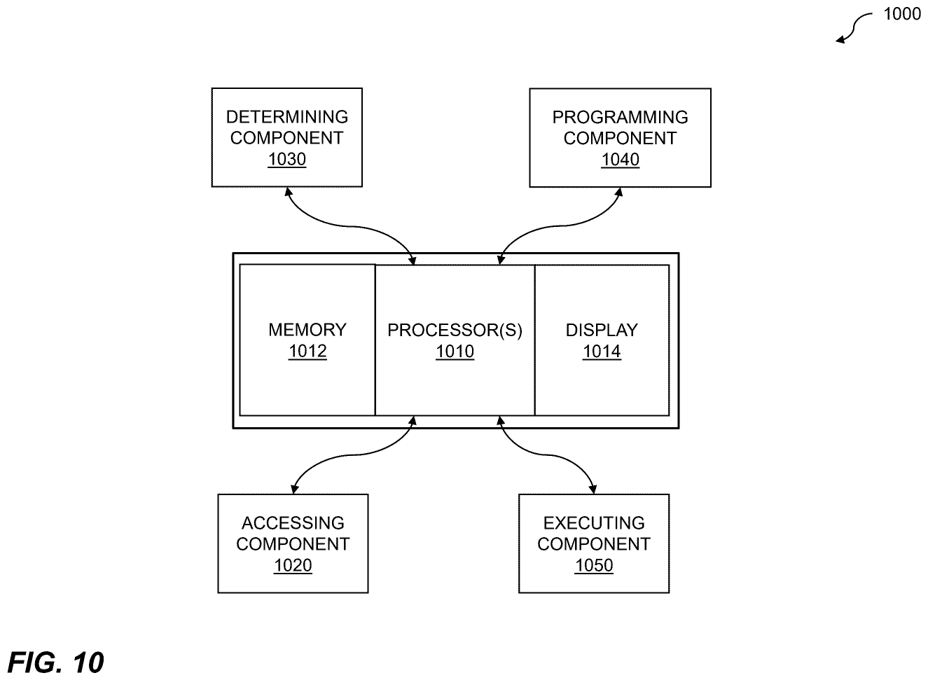

FIG. 10 is a system diagram for machine learning processing. The machine learning processing is enabled using flexible bit truncation. The system 1000 can include one or more processors 1010, which are coupled to a memory 1012 that stores instructions. The system 1000 can further include a display 1014 coupled to the one or more processors 1010 for displaying data, truncated data, untruncated data, machine learning network configurations, flexible bit truncation settings, and so on. In embodiments, one or more processors 1010 are coupled to the memory 1012, wherein the one or more processors, when executing the instructions which are stored, are configured to: access a machine learning network, wherein the machine learning network includes one or more processing layers, and wherein at least one of the one or more processing layers is sourced with flexible bit truncation storage hardware; determine a flexible bit truncation setting for the at least one of the one or more processing layers, wherein the determining is based on an application to be executed on the machine learning network; program the flexible bit truncation setting in the flexible bit truncation storage hardware of the at least one of the one or more processing layers; and execute the application, using the flexible bit truncation setting.

The system 1000 can include an accessing component 1020. The accessing component can access a machine learning network. The machine learning network can include a neural network configured for machine learning, a deep learning network, and so on. The machine learning network can include a convolutional neural network (CNN). The machine learning network can include one or more layers. The layers can include an input layer, an output layer, one or more intermediate or hidden layers, and the like. The layers of the machine learning network process data such as image data, audio data, video data, and so on. The machine learning network can be trained using training data, where the training data is labeled with expected classifications. At least one of the one or more processing layers is sourced with flexible bit truncation storage hardware. The flexible bit truncation storage hardware can source data the length of which has been truncated. The truncated data can include data with one or more least significant bits (LSB) of data truncated. The flexible bit truncation storage hardware can be used to store various datatypes such as characters, symbols, numbers, and so on. The numbers can be written to and read from the storage hardware based on a variety of numeric representations such as integer, real, floating-point, single-precision, double-precision, etc.

The machine learning network can be trained and configured to execute an application such as an image processing application. Discussed previously and throughout, a layer of the machine learning network can be sourced with flexible bit truncation storage hardware. The number of LSBs truncated by the truncation storage hardware while sourcing the machine learning network can depend on the application that is executing. The number of bits that are truncated can include zero LSBs, one LSB, and so on. That is, the data that is sourced can remain untruncated or can be truncated. In embodiments, at least two of the one or more processing layers can be sourced with flexible bit truncation storage hardware. The number of LSBs that are truncated can be based on a setting (described below). The settings for each layer can be substantially similar or substantially dissimilar.

The system 1000 can include a determining component 1030. The determining component can determine a flexible bit truncation setting for the at least one of the one or more processing layers. The flexible bit truncation setting can include truncating zero LSBs, one LSB, two LSB, and so on. The determining is based on an application to be executed on the machine learning network. The application to be executed can include an image or audio processing application, a natural language processing application, a video processing application, and so on. The determining can be based on a factor or criterion such as convergence rate, classification accuracy, and so on. In a usage example, a convolutional neural network model such as a VGG-16 model can be compared to a lightweight model such as a filter-pruned lightweight VGG-16 model. The models can be evaluated for different numbers of truncation bits, and the results compared for classification accuracy, inference convergence rate, etc. Embodiments can further include determining at least one additional flexible bit truncation setting. The flexible bit truncation setting, and the additional flexible bit truncation setting, can be applied to different layers within the machine learning network. In embodiments, the at least one additional flexible bit truncation setting can be different from the flexible bit truncation setting.

The system 1000 can include a programming component 1040. The programming component can program the flexible bit truncation setting in the flexible bit truncation storage hardware of the at least one of the one or more processing layers. The programming the flexible bit truncation setting can include providing the truncation setting to a truncation manager. The truncation manager can enable or disable one or more bitlines associated with one or more LSBs in the bit truncation storage hardware. The truncation manager can further select storage output lines using one or more multiplexers. Embodiments can further include programming the at least one additional flexible bit truncation setting in another of the one or more processing layers. Discussed above, the flexible bit truncation setting, and the additional flexible truncation setting can be substantially similar or substantially dissimilar. The programming can occur at a convenient point in application execution on the machine learning network. In embodiments, the programming the flexible bit truncation setting can occur in real time during application runtime. As the application is executed on the machine learning network, requirements such as data precision requirements can change. The changes can be applied to one or more layers within the machine learning network. In embodiments, the programming the flexible bit truncation setting can change dynamically during runtime. The dynamic change during runtime can occur for processing efficiency, relaxed precision requirements, etc.

In addition to reducing processing complexity while maintaining sufficient data classification, inference convergence, and so on, truncating data can be used to control power consumption, to reduce heat dissipation, etc. within the machine learning network. In embodiments, the programming can disable one or more current paths in a truncated portion of the flexible bit truncation storage hardware. In a usage example, three LSBs are truncated from the data. Since the truncated LSBs will not be used to load (read) data from the storage element, the bitlines associated with the truncated LSBs do not need to be precharged. When bitlines are not precharged, power consumption by the flexible bit storage hardware is reduced. Heat dissipation by the storage hardware is also reduced. The powering bitlines and the precharging (nor not precharging) bitlines can be accomplished by selectively distributing power along each of the bitlines. The distributing is accomplished by coupling bitline power header devices to each of the bitlines. The bitlines can include the true bitlines and the complement bitlines. Recall that power can be distributed to bitlines prior to loading data from RAM elements within the flexible bit truncation storage hardware. In embodiments, the flexible bit truncation storage hardware can include a static RAM (SRAM). The power is distributed such that when the contents of storage hardware are enabled to the bitlines via pass transistors associated with the RAM elements (e.g., SRAM cells), the voltage on the bitlines, bitline true and bitline complement, are slightly disturbed in opposite directions. That is, the voltage on one bitline rises while the voltage on the other bitline drops. When designed properly, the contents of the SRAM cells recover when the SRAM cell is disconnected from the bitlines. Power can be distributed to the bitlines, or not when the bitlines are selectively decoupled by the truncation manager, using pullup devices and pulldown devices. In embodiments, the power header devices can include a power header device pair. The pullup devices can include p-type devices such as PMOS devices, while the pulldown devices can include n-type devices such as NMOS devices. The PMOS device and the NMOS device can comprise a power header device pair. In embodiments, a p-type power header device of the power header device pair can control source current power distribution for the bitline. In other embodiments, an n-type power header device of the power header device pair can control sink current power distribution for the bitline.

The bits that are truncated need to be handled properly in order to avoid loading erroneous data. The values that are associated with truncated LSBs can be set. Further embodiments can include setting a most significant bit of a truncated portion of the flexible bit truncation storage hardware to a 0b1 value. The setting can be accomplished using a p-mos pullup device, a multiplexer, etc. Other bits of the truncated bits also need to be handled properly. Further embodiments can include setting a next most significant bit of a truncated portion of the flexible bit truncation storage hardware to a 0b value. The bit value equal to zero can be accomplished using an n-mos pulldown device, a multiplexer, and the like. When more than two LSBs are truncated, the remaining truncated bits can be set a value. Further embodiments can include setting the rest of the bits of a truncated portion of the flexible bit truncation storage hardware to a 0b0 value. The setting the rest of the bits of a truncated portion ensures that a known value is set and loaded, rather than a random or unknown value.

The system 1000 can include an executing component 1050. The executing component can execute the application, using the flexible bit truncation setting. Recall that the application can include a data processing application. The application can include an audio processing application, an image processing application, a video processing application, and so on. The application can further include a trained machine learning application, a natural language processing application, etc. The application can be executed based on the one or more flexible bit truncation settings that were determined. In embodiments, the executing can include using the at least one additional flexible bit truncation setting. As the application is executing, a classification determined, an inference drawn, and the like, can be used to adjust the flexible bit truncation setting for one or more layers of the machine learning network. The adjustment of the setting can be based on a need for increased precision (e.g., fewer truncated LSBs), a processing task that dictates decreased precision (e.g., more truncated LSBs), and so on. Thus, in embodiments, the programming the flexible bit truncation setting can change dynamically during runtime.

In embodiments, the accessing, the determining, the programming, and the executing can include machine learning truncated inference. Artificial intelligence (AI) models such as machine learning models can be based on a decision tree. The decision tree is a technique that enables a model to make fast, simple decisions about data. The tree includes decision points and branches. The decision associated with the decision point can be made based on a “yes or no” decision, a value, a probability, and so on. In a usage example, an image includes a house. At the decision point, “does the image contain a house?”, the answer can be “yes” or “no.” If yes, then one branch is taken. If no, the other branch is taken. Further could include “maybe” (e.g., not clearly yes or no), “maybe not,” etc. As a result, the decision tree can quickly become large and unwieldy. To better control the size of the decision tree, the tree can undergo “truncation” and “pruning.” Truncation is a technique that can stop the increase of the size of the decision tree. Truncation can be used to reduce a tendency of the decision tree to overfit the data it is being used to process. Pruning, on the other hand, is a technique that can be used to remove branches of the decision tree, starting from the farthest branches or “leaves” of the tree and working back up toward the root of the decision tree. Deciding which branches to prune can be based on application of appropriate datasets to the decision tree. The appropriate datasets can include a training dataset, a validation dataset, and a test dataset. The pruning can be based on proposing to prune a branch and calculating a metric such as an accuracy metric, a classification metric, a convergence rate metric, etc. The metric can be calculated for the performance of the decision tree before pruning and after pruning. If the metric meets a specified threshold after pruning, then the branch can be pruned. If the metric does not meet the specified threshold, the branch is not pruned. The pruning technique can be repeated as necessary to balance the reduction of decision tree size while maintaining one or more desired metrics. The truncation and the pruning enable machine learning truncated inference.

Returning to applications, a variety of applications can be executed on the machine learning network. The machine learning network can be executing an application, where the execution can be analyzed. Further embodiments can include analyzing the application for one or more flexible bit truncation settings. The one or more flexible bit truncation settings can be calculated, estimated, predicted, and so on. The results of the truncation settings can be compared. The comparison can be based on analysis. In embodiments, the analyzing is based on application layer execution accuracy. The execution accuracy, such as classification accuracy, can be determined for zero truncation bits, one truncation bit, two or more truncation bits, etc. The determined execution accuracy can be compared to a value, a threshold, a percentage, etc. In embodiments, the analyzing can be based on application final result accuracy. The final result accuracy can include a classification accuracy, rate of convergence for an inference, and the like. In embodiments, the analyzing can include machine learning truncated training pruning. Discussed previously, a decision tree associated with the application can be pruned based on the application final result accuracy.

One benefit to analyzing applications is that the applications can be grouped based on application type, application performance, truncation bit settings, and so on. Further, when a new application is introduced, analysis of previous application of a similar or related type can be used to guide machine learning network settings, such one or more flexible bit truncation settings. In embodiments, the analyzing is catalogued into a generic application type. An example generic application type can include an audio application type, a video application type, a natural language type, etc. In embodiments, the generic application type can be stored in a catalog. The catalog can include one or more generic application types. In embodiments, entries in the catalog are used as a proxy analysis for an unanalyzed application type. The entries in the catalog can provide initial settings such as truncation bit settings for the unanalyzed application type. The catalog can include one or more entries for a variety of application types. In embodiments, the entries in the catalog can include image analysis, deep neural network processing, or generative artificial intelligence. The entries can further include generative adversarial network (GAN) entries.

The system 1000 can include a computer program product embodied in a non-transitory computer readable medium for machine learning processing, the computer program product comprising code which causes one or more processors to perform operations of: accessing a machine learning network, wherein the machine learning network includes one or more processing layers, and wherein at least one of the one or more processing layers is sourced with flexible bit truncation storage hardware; determining a flexible bit truncation setting for the at least one of the one or more processing layers, wherein the determining is based on an application to be executed on the machine learning network; programming the flexible bit truncation setting in the flexible bit truncation storage hardware of the at least one of the one or more processing layers; and executing the application, using the flexible bit truncation setting.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for machine learning processing comprising:
accessing a machine learning network, wherein the machine learning network includes one or more processing layers, and wherein at least one of the one or more processing layers is sourced with flexible bit truncation storage hardware;
determining a flexible bit truncation setting for the at least one of the one or more processing layers, wherein the determining is based on an application to be executed on the machine learning network;
programming the flexible bit truncation setting in the flexible bit truncation storage hardware of the at least one of the one or more processing layers; and
executing the application, using the flexible bit truncation setting.

2. The method of claim 1 wherein at least two of the one or more processing layers are sourced with flexible bit truncation storage hardware.

3. The method of claim 2 further comprising determining at least one additional flexible bit truncation setting.

4. The method of claim 3 wherein the at least one additional flexible bit truncation setting is different from the flexible bit truncation setting.

5. The method of claim 4 further comprising programming the at least one additional flexible bit truncation setting in another of the one or more processing layers.

6. The method of claim 5 wherein the executing includes using the at least one additional flexible bit truncation setting.

7. The method of claim 1 wherein the programming the flexible bit truncation setting occurs in real time during application runtime.

8. The method of claim 1 wherein the programming the flexible bit truncation setting changes dynamically during runtime.

9. The method of claim 1 wherein the accessing, the determining, the programming, and the executing comprise machine learning truncated inference.

10. The method of claim 1 further comprising analyzing the application for one or more flexible bit truncation settings.

11. The method of claim 10 wherein the analyzing is based on application layer execution accuracy.

12. The method of claim 10 wherein the analyzing is based on application final result accuracy.

13. The method of claim 10 wherein the analyzing comprises machine learning truncated training pruning.

14. The method of claim 10 wherein the analyzing is catalogued into a generic application type.

15. The method of claim 14 wherein the generic application type is stored in a catalog.

16. The method of claim 15 wherein entries in the catalog are used as a proxy analysis for an unanalyzed application type.

17. The method of claim 16 wherein the entries in the catalog include image analysis, deep neural network processing, or generative artificial intelligence.

18. The method of claim 1 wherein the programming disables one or more current paths in a truncated portion of the flexible bit truncation storage hardware.

19. The method of claim 1 further comprising setting a most significant bit of a truncated portion of the flexible bit truncation storage hardware to a 0b1 value.

20. The method of claim 19 further comprising setting a next most significant bit of a truncated portion of the flexible bit truncation storage hardware to a 0b0 value.

21. The method of claim 20 further comprising setting the rest of the bits of a truncated portion of the flexible bit truncation storage hardware to a 0b0 value.

22. A computer program product embodied in a non-transitory computer readable medium for machine learning processing, the computer program product comprising code which causes one or more processors to perform operations of:
accessing a machine learning network, wherein the machine learning network includes one or more processing layers, and wherein at least one of the one or more processing layers is sourced with flexible bit truncation storage hardware;
determining a flexible bit truncation setting for the at least one of the one or more processing layers, wherein the determining is based on an application to be executed on the machine learning network;
programming the flexible bit truncation setting in the flexible bit truncation storage hardware of the at least one of the one or more processing layers; and
executing the application, using the flexible bit truncation setting.

23. A computer system for machine learning processing comprising:
a memory which stores instructions;
one or more processors coupled to the memory, wherein the one or more processors, when executing the instructions which are stored, are configured to:
access a machine learning network, wherein the machine learning network includes one or more processing layers, and wherein at least one of the one or more processing layers is sourced with flexible bit truncation storage hardware;
determine a flexible bit truncation setting for the at least one of the one or more processing layers, wherein the determining is based on an application to be executed on the machine learning network;
program the flexible bit truncation setting in the flexible bit truncation storage hardware of the at least one of the one or more processing layers; and
execute the application, using the flexible bit truncation setting.
